(19) United States
(12) Patent Application Publication
(10) Pub. No.: US 2011/0246790 A1
(43) Pub. Date: Oct. 6, 2011

(54) SECURED REMOVABLE STORAGE DEVICE

(75) Inventors: Wei-hu Koh, Irvine, CA (US); Ho-Yin Chan, Tsing Yi (HK)

(73) Assignee: GAINTEAM HOLDINGS LIMITED, Tsing Yi (HK)

(21) Appl. No.: 12/752,020

(22) Filed: Mar. 31, 2010

(51) Int. Cl. G06F 12/14

(52) U.S. Cl. 713/193; 711/103; 711/164

(57) ABSTRACT

This present disclosure combines a data storage drive, such as flash-based USB drive or a SSD drive with redundant, multiple levels of security protection. In an embodiment, the security protection includes password protection, fingerprint recognition, and real-time data encryption. The biometric sensors may be integrated into the storage device without substantially adding weight and size. Further, the secured device may have a built-in internal power source to self-sustain the protection without having to connect to a host device or an external power source. Thus, it is possible to remotely track the location of the secured device and disable or enable the security protection or manage the security setups.

### TECHNICAL FIELD

The present disclosure generally relates to the field of memory storage device, and more particularly, to a removable digital memory storage device for data storage with self-contained security protection/management and multiple security functions.

### BACKGROUND

Conventional remote (not embedded inside a host device) or removable memory storage devices, such as external USB flash memory drives or external hard disk drives (HDD), can store digital data files while being portable from one device to another, which makes the transfer of data from a host device to another very convenient. To protect the data content, the conventional removable devices may include a biometric sensor or require a password as a gate for authentication. Such security protections usually rely on the CPU inside the host device, such as a PC or a notebook, to perform the necessary computation tasks for the authentication process (e.g., data processing to recognize the fingerprint patterns from the sensor, or installation of encryption). That is, the removable storage devices must be first connected to a host device and then use the CPU, operating system, and/or drivers of the host device to compute and perform the authentication tasks.

### SUMMARY

One exemplary embodiment of the present disclosure is directed to a secured removable storage device operable to communicate with a host device. The secured removable storage device comprises: a non-volatile memory module; a biometric module operable to process biometric data; a display module operable to sense and receive biometric data and to display information and allow a user to enter data; an interface for communicating with the host device; and a microcontroller module. The microcontroller module is in communication with the non-volatile memory module, the biometric module, and the display module such that the microcontroller module is operable to verify the identity of the user using the biometric data and selectively allow access to the storage device.

Another exemplary embodiment of the present disclosure is directed to a secured removable storage device operable to communicate with a host. The secured removable storage device comprises: a non-volatile memory module; a biometric module operable to sense, receive, and process biometric data; an interface for communicating with the host; a microcontroller module; a tracking module comprising a GPS unit for tracking the location of the secured removable storage device; and an embedded power source operable to provide power to the non-volatile memory module, the biometric module, the tracking module, and the microcontroller module. The microcontroller module is in communication with the non-volatile memory module, the biometric module, and the tracking module such that the microcontroller module is operable to verify the identity of the user using the biometric data and selectively allow access to the storage device.

### BRIEF DESCRIPTION OF THE DRAWINGS

In order to understand the manner in which embodiments of the present disclosure are obtained, a more particular description of various embodiments of the disclosure briefly described above will be rendered by reference to the appended drawings. It is to be appreciated that these drawings depict only typical embodiments of the disclosure and are not necessarily drawn to scale and are not therefore to be considered to be limited of its scope. The embodiments of the disclosure will be described and explained with additional specificity and detail through the use of the accompanying drawings in which:

FIG. 1 shows a perspective view of a removable memory storage in the prior art;

FIG. 2 shows an exemplary structure of a single circuit board of a secured removable storage device according to one embodiment of the present disclosure;

FIG. 3 shows a perspective view of a secured removable storage device according to one embodiment of the present disclosure;

FIG. 4 shows a perspective view of a secured removable storage device according to another embodiment of the present disclosure; and

FIG. 5 shows a perspective view of a secured removable storage device according to yet another embodiment of the present disclosure.

### DETAILED DESCRIPTIONS

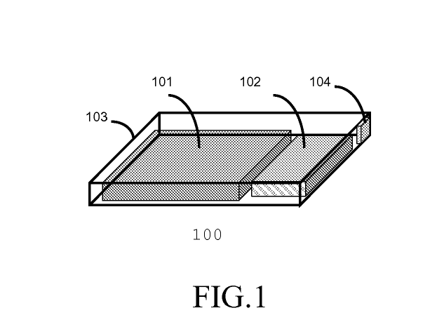

FIG. 1 illustrates a conventional external HDD 100. The external HDD 100 includes a memory module 101 and an additional biometric fingerprint sensor 102, which is added on to the external hard drive 100 by using a bridge circuit board (not shown). After connecting the memory module 101 to the bridge circuit, the memory module 101 and the fingerprint sensor 102 are enclosed in a larger housing 103 that provides either a port (e.g. a USB port) 104 or a cable (not shown) for connection to a host PC device. In some embodiments, it is also possible to connect a solid-state drive (SSD) to the biometric sensor bridge and enclose both with another casing. The conventional external HDD 100, enables fingerprint protection after the device is connected to a host device, but adds additional weight and size. Further, when lost or stolen, the housing 103 may be opened, and the hard drive inside can be accessed by bypassing the biometric protection gate.

Accordingly, it may be desirable to provide both internal data encryption and external biometric protection to high-capacity data storage while not significantly adding to the size and weight of the original device. It may also be desirable that the add-on biometric sensor components are not easily separated for access to the original storage device.

Furthermore, conventional computers without an internal, built-in security management enabling device or software may rely on an external device, such as a fingerprint pad, connected to the host device through a USB cable/port, to enable data encryption for files storage in the main internal drives. This requires the addition of another auxiliary device, the external biometric fingerprint pad, for example. Thus, if one is to use an external mouse, an external fingerprint pad, and external data storage drive, one needs to carry three additional, separate devices. If a single device can combine the functions of all three devices, then a user needs only to carry one device instead of three, which provides more convenience to the users and reduces the weight of carrying all three devices while traveling. Therefore, there may be needs for integrated devices that can perform some or all of the above discussed functions.

One aspect of the present disclosure is directed to a multifunctional, self-contained secured removable storage device that, in some embodiments, may not rely on a host for data protection. The device may include integrated, multi-level, hardware- and software-based security protections that operate independent from any host device, thereby allowing independent security management on the storage device alone. The integration of security protections in one independent device affords a degree of protection that cannot be achieved by individually implementing the same security mechanisms.

Another aspect of the present disclosure is directed to a multifunctional, self-contained secured removable storage device that has disassembly-proof mode and GPS protection mode. It may be desirable that all these features/components can be integrated in a single circuit board.

In the following detailed description, reference is made to the accompanying drawings that show, by way of illustration, specific embodiments in which the disclosure may be practiced. These embodiments are described in sufficient detail to enable those skilled in the art to practice the disclosure. It is to be understood that the various embodiments of the disclosure, although different, are not necessarily mutually exclusive. For example, a particular feature, structure, or characteristic described herein, in connection with one embodiment, may be implemented within other embodiments without departing from the spirit and scope of the disclosure.

In addition, it is to be understood that the location or arrangement of individual elements within each disclosed embodiment may be modified without departing from the spirit and scope of the disclosure. The following detailed description is, therefore, not to be taken in a limiting sense, and the scope of the present disclosure is defined only by the appended claims, appropriately interpreted, along with the full range of equivalents to which the claims are entitled.

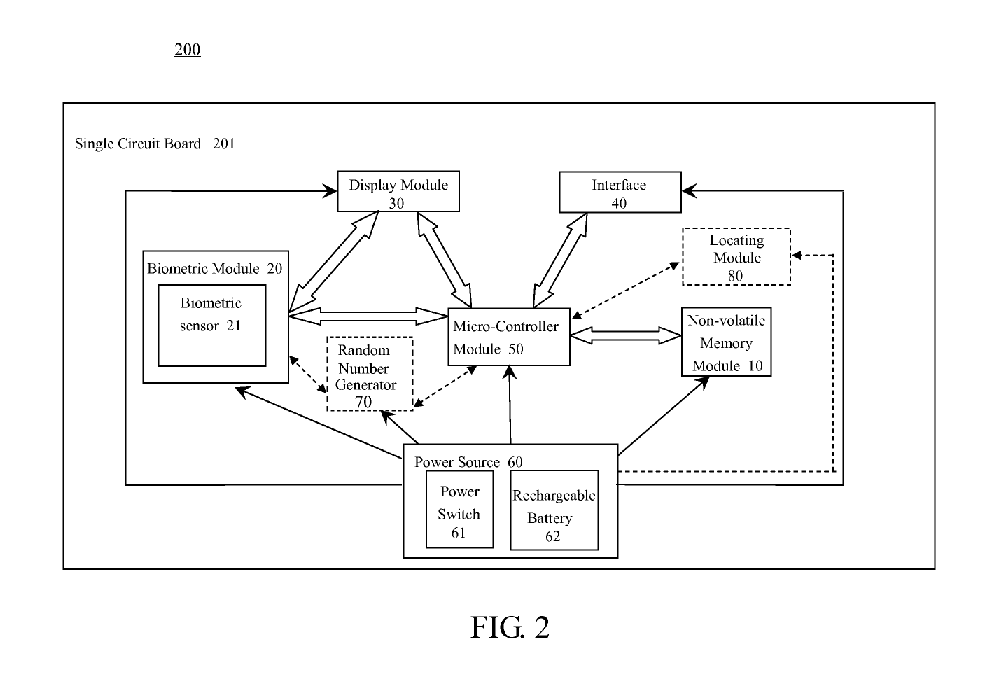

FIG. 2 is a schematic diagram showing an exemplary single circuit board 201 of a secured removable storage device 200 according to one embodiment of the present disclosure. As shown in FIG. 2, the single circuit board 201 includes a non-volatile memory module 10 for storing data file; a biometric module 20 for sensing and receiving biometric data; a display module 30 operable to function as both an input window for receiving data and a display for displaying the status of security and data file management; an interface 40 for communicating with a host; a microcontroller module 50 operatively connected with the other modules or components for managing security and controlling the operation of the storage device 200. The circuit board 201 may further include an embedded power source 60, which may be rechargeable and may provide power to all the modules or components of the single circuit board 201.

In some embodiments, the biometric module 20 comprises a biometric sensor 21 for sensing and receiving voice signal data. The biometric sensor 21 may be a voice sensor, such as a microphone. However, those skilled in the art may understand that, the present disclosure is not so limited.

The power source 60 may be comprised of a power switch 61 and a rechargeable battery 62. The power switch may be configured to have a default “power-on” mode. In an embodiment, it may be configured such that switching from the power-on to a power-off mode can only be done through the display module 30 after passing predetermined security procedures. In an exemplary embodiment, the power switch 61 can only be turned off through a secured soft-key on the display module, such as a multifunctional touch screen. However, those skilled in the art may understand that, the present disclosure is not so limited.

Moreover, the non-volatile memory module 10 may be a solid-state drive (SSD), a HDD, or a Flash memory, including a NAND Flash memory. The interface 40 may be at least one of USB 2.0, USB 3.0, peripheral component interconnect express (PCI-E), external serial advanced technology attachment (eSATA), integrated drive electronics (IDE), infrared interface, and Bluetooth.

Those skilled in the art may understand that the rechargeable battery in some embodiments may be a Ni-Cd battery, a Ni-MH battery, a lithium-ion battery, a Li-Pol battery, or a SLA battery. The single circuit board 201 of the secured removable storage device 200 may contain other numbers of the biometric sensor, the non-volatile memory, the display module, the interface and the rechargeable battery respectively, and all kinds of variations shall fall into the scope of the present disclosure.

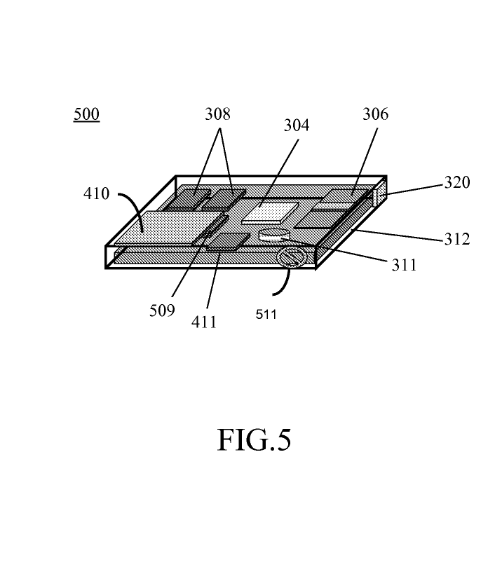

In accordance with one embodiment of the present disclosure, the single circuit board 201 may also include other modules or components. In an embodiment, a random number generator 70 is linked to the display module 30 and the microcontroller module 50 for generating a sequence of periodic random alphanumeric number displayed in the display module 30 for verification. In another embodiment, a tracking module 80 is powered by the embedded power source 60 with a GPS unit (as shown in FIG. 5) for tracking and locating the location of the secured removable storage device. In another embodiment, a wireless module (as shown in FIG. 4) is powered by the embedded power source 60 for data transmission through a wireless network. In another embodiment, a tamper-proof module (not shown) is powered by the embedded power source 60 for triggering a partial or complete destruction of the storage device 200 once the storage device 200 is being tampered, disassembled and/or damaged. Those skilled in the art can understand that the present disclosure is not necessarily to include all these modules or components at same time.

All the above-mentioned modules will be respectively described with other Figures in different embodiments according to the present disclosure.

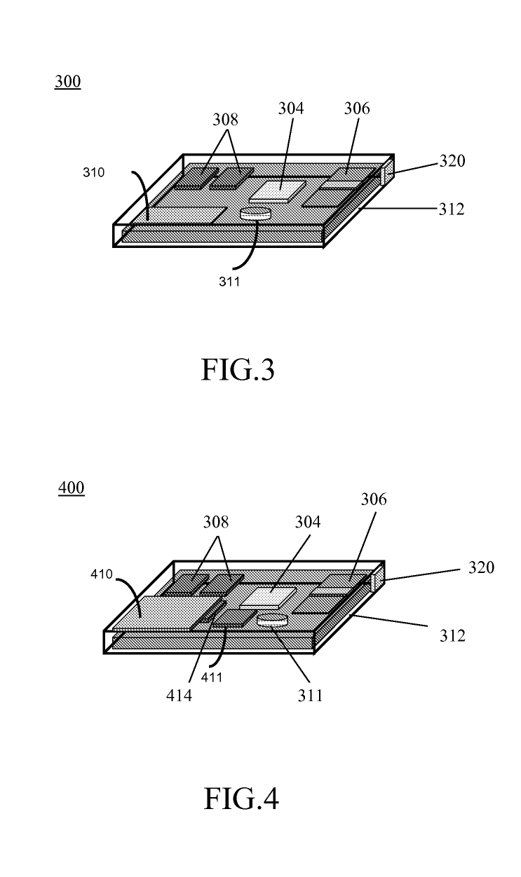

FIG. 3 is a schematic diagram showing a perspective view of a secured removable storage device 300 according to one embodiment of the present disclosure. The secured removable storage device 300 comprises a microcontroller module 304 in communication with a biometric module 306 two flash memories 308 and a display module 310. The storage device 300 may also include a power source 311, an interface 320 and a housing 312. While the secured removable storage device 300 is connected to a host (not shown) via the USB interface 320, the power source 311 may be recharged via the USB interface. The housing 312 encloses an interior space, wherein the above discussed modules or components are either directly or indirectly supported by the housing. The housing has at least one access region through which the biometric module 306, the display module 310 (e.g., a touch-screen) and the interface 320 are respectively accessible from the exterior of the housing 312. In the embodiment illustrated in FIG. 3, the housing 312 has three access regions.

A user may be required to go through an authentication process before given access to the data files in the secured removable storage device 300. The authentication process may contain multiple levels of security measures comprising any combination of the following: biometric fingerprint recognition, password recognition, handwriting signature recognition, and any other security measures know in the art. In an embodiment, a touch-screen 310 of device 300 may be operable to sense and receive fingerprint or other biometric information and transmit the biometric information to the biometric module 306. In another embodiment, the biometric module 306 may include an integrated biometric senor operable to sense and receive fingerprint or other biometric information.

Upon obtaining the biometric data, the biometric module 306 is operable to process the biometric data, and send a corresponding signal to the microcontroller module 304. The microcontroller module 304 may match the signal with information stored in a users database stored in the flash memory 308. If the biometric data matches with one of the recorded users of the device 300, the user may proceed to a second level for further authentication. In an embodiment, in the second level, the user has to input a certain password by a soft keypad displayed on the touch-screen 310. In another embodiment, the visitor may input a handwriting signature using the touch-screen 310, which may allow the user to input in different languages in addition to English alphanumeric, such as Chinese, Japanese, Arabic, etc. Therefore, the password or signature can be in a different language. Finally, if the visitor passes all the security recognition steps, the device can be used as a normal storage device.

Those skilled in the art may appreciate that the combination of the multiple recognitions may be in different order and other combinations of the above-mentioned recognition methods are easily understood, such as combination of fingerprint recognition once and password recognition twice and so on. Of course, the present disclosure is not limited in this aspect, and other embodiments may occur to those skilled in the art.

Even without connecting to any host device, a user may finish managing the secured removable storage device 300 powered by the lithium-ion battery 311 after passing the recognition as described above. In this way, the user may store new passwords, new handwriting signatures, or new users' fingerprints. Furthermore, the user can also enable special working modes like “tamper-proof mode” or “locating mode”.

FIG. 4 is a schematic diagram illustrating a perspective view of a secured removable storage device 400 according to another embodiment of the present disclosure. The secured removable storage device 400 is similar to device 300 shown in FIG. 3. Moreover, the device 400 further comprises a wireless module 414 and a random number generator 411. The random number generator 411 is linked to the display module 410 and the microcontroller 304 for generating a sequence of periodic random alphanumeric number displayed in the display module for verification. As such, the device 400 is operable to provide an additional security-related recognition. In an embodiment, the touch-screen 410 first displays the sequence of random alphanumeric number generated by the random number generator 411. After that, the user would need to input the random alphanumeric number by the soft keypad displayed on the touch-screen 410, and the microcontroller module 304 would verify the inputs. The random number recognition may be used with the above-mentioned multiple recognitions, for example, inputting with the password together.

In an exemplary embodiment, the random number generator 411 may generate various alphanumeric number patterns at different time or on demand For example, the random number may be displayed on an upper part of the touch-screen 410 window while the lower part of the window shows a virtual keypad for the user to re-enter the random number. Once the recognition process is completed, the device 400 can then be used for a specified period determined by the user (such as one hour, 24 hours, one week, etc.). When the pre-specified period expires, the user must re-enter the same number again to continue. Otherwise, the entire registration process must be started anew. It is to be appreciated that the present disclosure is not limited in this aspect, and other embodiments may occur to those skilled in the art.

FIG. 5 is a schematic diagram illustrating a perspective view of a secured removable storage device 500 according to yet another embodiment of the present disclosure. The secured removable storage device 500 is similar to the device 300 as shown in FIG. 3. Moreover, the device 500 further comprises a tracking module with a GPS unit 509 for tracking and locating the location of the secured removable storage device 500. Once registered in another host device, the location of the removable data storage device 500 can be tracked and located. For example, if the device 500 is lost, the device location can be found using the GPS unit 509. In an embodiment, the GPS unit 509 allows a remote trigger to disable the operation of the device or deny access to the device 500. The actually disabling of the device 500 can be accomplished by any means known in the art. As such, data files in the device already scrambled by security encoding would not be decoded.

In accordance with an embodiment of the present disclosure, the secured removable storage device may further comprise a tamper-proof module (not shown) powered by the embedded power source for triggering a partial or complete destruction of the storage device 500 once the storage device 500 is being tampered, disassembled and/or damaged. The tamper-proof module may comprise at least one disassembly sensor for sensing the disassembly when tamper-proof mode is activated. Optionally, the tamper-proof module may be activated in many manners, such as electrical manners, mechanical manners, electromechanically manners or optical manners. The disassembly sensor in accordance with the embodiment of the present disclosure may be of contact or contactless type, such as being embodied by photoelectric sensor, mechanical moving detector, vibration sensor and the like. However, the present disclosure is not so limited, other variations may occur to those skilled in the art, and these variations fall into the scope of the present disclosure.

The device 500 may further include a random number generator 411, which may be identical to the one shown in FIG. 4, and a biometric module comprising a voice sensor 511 for sensing and receiving voice signal data. To those skilled in the art, the voice recognition is well-known and those skilled in the art may appreciate that the voice recognition may be used with the above-mentioned multiple recognitions.

Of course, the present disclosure is not limited in this aspect, and other embodiments may occur to those skilled in the art.

It is to be appreciated that the secured storage devices of the present disclosure may include multiple security measures, including biometric fingerprint recognition, biometric voice recognition, password recognition, handwriting signature recognition, random number recognition, locating mode and tamper-proof mode, and may be used individually or in any combination with each other. Although several security measures have been described with embodiments in detail above, the embodiments described are exemplary and are not limiting, other variations may occur to those skilled in the art, and these variations fall into the scope of the present disclosure. Moreover, combinations of the multiple security measures may achieve a security system that can be used in many different applications according to design needs.

The disclosures are not restricted to the particular details listed herein. Indeed, those skilled in the art having the benefit of this disclosure will appreciate that many other variations from the foregoing description and drawings may be made within the scope of the present disclosure. Accordingly, it is the appended claims including any amendments thereto that define the scope of the disclosures. The terms and expressions which have been employed herein are used as terms of description and not of limitation, and there is no intention, in the use of such terms and expression, of excluding any equivalents of the features shown and described (or portions thereof), and it is recognized that various modifications, variations, alternatives, and equivalents are possible within the scope of the claims. Accordingly, the claims are intended to cover such modifications, variations, alternatives, and equivalents.

What is claimed is:

1. A secured removable storage device operable to communicate with a host device, the secured removable storage device comprising:
a non-volatile memory module;
a biometric module operable to process biometric data;
a display module operable to sense and receive biometric data, to display information, and to allow a user to enter data;
an interface operable to communicate with the host device; and
a microcontroller module; and
wherein the microcontroller module is in communication with the non-volatile memory module, the biometric module, and the display module such that the microcontroller module is operable to verify the identity of the user using the biometric data and selectively allow access to the storage device.

2. The secured removable storage device according to claim 1, further comprising:
a housing enclosing an interior space, wherein the non-volatile memory module, the biometric module, the display module, the interface and the microcontroller module are supported by the housing, and the housing has at least one access region through which the biometric module, the display module, and the interface are respectively accessible from the exterior of the housing.

3. The secured removable storage device according to claim 2, wherein the housing comprises a first portion connected to a second portion, the first and second portions cooperating to enclose the interior space.

4. The secured removable storage device according to claim 2, wherein the secured removable storage device further comprises an embedded power source and a tamper-proof module powered by the embedded power source, the tamper-proof module being operable to trigger a partial or complete destruction of the storage device.

5. The secured removable storage device according to claim 4, wherein the tamper-proof module comprises at least one sensor operable to detect a disassembly of the housing.

6. The secured removable storage device according to claim 1, wherein the non-volatile memory module comprises at least one of a solid-state drive, a hard disk drive, or a flash memory.

7. The secured removable storage device according to claim 1, further comprising an embedded power source operable to provide power to the non-volatile memory module, the biometric module, the display module, and the microcontroller module.

8. The secured removable storage device according to claim 7, wherein the embedded power source comprises a rechargeable battery.

9. The secured removable storage device according to claim 8, wherein the rechargeable battery comprises at least a lithium-ion battery.

10. The secured removable storage device according to claim 1, wherein the biometric module comprises a voice sensor operable to sense and receive voice signal data.

11. The secured removable storage device according to claim 1, wherein the display module comprises a touch-screen, and the security data includes a password or a handwriting signature.

12. The secured removable storage device according to claim 11, wherein the touch screen comprises a soft keypad.

13. The secured removable storage device according to claim 1, further comprising a random number generator in communication with the display module and the microcontroller.

14. The secured removable storage device according to claim 1, wherein the interface comprises at least one of USB 2.0, USB 3.0, peripheral component interconnect express (PCI-E), external serial advanced technology attachment (eSATA), integrated drive electronics (IDE), infrared interface, or Bluetooth.

15. The secured removable storage device according to claim 1, wherein the secured removable storage device further comprises an embedded power source and a wireless module powered by the embedded power source, the wireless module operable to transmit data to the host device through a wireless network.

16. The secured removable storage device according to claim 1, wherein the secured removable storage device further comprises an embedded power source and a tracking module powered by the embedded power source, the tracking module comprising a global positioning system (GPS) unit operable to track the location of the secured removable storage device.

17. A secured removable storage device operable to communicate with a host, the secured removable storage device comprising:
a non-volatile memory module;
a biometric module operable to sense, receive, and process biometric data;
an interface for communicating with the host;
a microcontroller module;
a tracking module comprising a global positioning system (GPS) unit operable to track the location of the secured removable storage device; and
an embedded power source operable to provide power to the non-volatile memory module, the biometric module, the tracking module, and the microcontroller module; and
wherein the microcontroller module is in communication with the non-volatile memory module, the biometric module, and the tracking module such that the microcontroller module is operable to verify the identity of the user using the biometric data and selectively allow access to the storage device.

18. The secured removable storage device according to claim 17, further comprising:
a housing enclosing an interior space, wherein the non-volatile memory module, the biometric module, the display module, the interface, tracking module, and the microcontroller module are supported by the housing, and the housing has at least one access region through which the biometric module, the display module and the interface are respectively accessible from the exterior of the housing.

19. The secured removable storage device according to claim 18, wherein the housing comprises a first portion connected to a second portion, the first and second portions cooperating to enclose the interior space.

20. The secured removable storage device according to claim 18, wherein the secured removable storage device further comprises a tamper-proof module powered by the embedded power source, the tamper-proof module operable to trigger a partial or complete destruction of the storage device.

21. The secured removable storage device according to claim 20, wherein the tamper-proof module comprises at least one sensor operable to detect a disassembly of the storage device.

22. The secured removable storage device according to claim 17, wherein the non-volatile memory module comprises at least one of a solid-state drive, a hard disk drive, or a flash memory.

23. The secured removable storage device according to claim 17, wherein the embedded power source comprises a rechargeable battery.

24. The secured removable storage device according to claim 23, wherein the rechargeable battery comprises at least a lithium-ion battery.

25. The secured removable storage device according to claim 17, wherein the biometric module comprises a voice sensor operable to sense and receive voice signal data.

26. The secured removable storage device according to claim 17, wherein the biometric module comprises a fingerprint sensor.

27. The secured removable storage device according to claim 17, further comprising a display module and an input device, the display module and the input device being in communication with the microcontroller module.

28. The secured removable storage device according to claim 27, further comprising a random number generator in communication with the display module and the microcontroller module.

29. The secured removable storage device according to claim 17, wherein the interface comprises at least one of USB 2.0, USB 3.0, peripheral component interconnect express (PCI-E), external serial advanced technology attachment (eSATA), integrated drive electronics (IDE), infrared interface, or Bluetooth.

30. The secured removable storage device according to claim 17, wherein the secured removable storage device further comprises a wireless module powered by the embedded power source, the wireless module being operable to transmit data to the host device through a wireless network.

31. The secured removable storage device according to claim 17, wherein the non-volatile memory module, the biometric module, the interface, the microcontroller module, the tracking module, and the power source are all integrated on a single circuit board.
